(19) United States
(12) Patent Application Publication
(10) Pub. No.: US 2005/0068780 A1
(43) Pub. Date: Mar. 31, 2005

(54) Optical axis control device for vehicle headlamp

(75) Inventor: Kenji Hayashi, Minato-ku (JP)

Correspondence Address: ROSSI & ASSOCIATES, P.O. BOX 826, ASHBURN, VA, 20146-0826, US

(73) Assignee: MITSUBISHI FUSO TRUCK AND BUS CORPORATION

(21) Appl. No.: 10/949,108

(22) Filed: Sep. 24, 2004

(30) Foreign Application Priority Data
Sep. 25, 2003 (JP) 2003-333350

(51) Int. Cl. F21W 11/10

(52) U.S. Cl. 362/460

(57) ABSTRACT

An optical axis control device for a vehicle headlamp detects the inclined state (inclination angle Δα) of a vehicle relative to a road surface during running of the vehicle, performs, in parallel, filtering for removing high frequency components of the detection data (for example, frequency components exceeding 0.1 Hz) (processing by first filter means), and filtering for removing high frequency components of the detection data (for example, frequency components exceeding 0.05 Hz) (processing by second filter means), updates the inclination angle Δα based on a plurality of data, and adjusts the inclination angle of a headlamp 5.

The entire disclosure of Japanese Patent Application No. 2003-333350 filed on Sep. 25, 2003, including specification, claims, drawings and summary, is incorporated herein by reference in its entirety.

### BACKGROUND OF THE INVENTION

1. Field of the Invention

This invention relates to an optical axis control device for adjusting the optical axis of a headlamp according to the inclined state of a vehicle. This invention is preferred, particularly when applied to a truck having a cab and a cargo bed provided on a frame.

2. Description of the Related Art

In recent years, high intensity lamps have been adopted from the viewpoint of safety. High intensity lamps contribute greatly to safety, but are highly likely to be dazzling to other vehicles. Thus, studies have been conducted on technologies for adjusting the optical axis of a headlamp according to the inclined status of a vehicle so as not to dazzle the driver of an oncoming vehicle.

Japanese Patent Application Laid-Open No. 1998-166933, hereinafter referred to as Patent Document 1, proposes such an optical axis adjusting apparatus for adjusting the optical axis of a headlamp according to the inclined status of a vehicle. “A vehicle headlamp optical axis direction automatic adjusting apparatus” described in Patent Document 1 calculates a pitch angle in a longitudinal direction of a vehicle based on signals from height sensors disposed on front and rear wheels of a vehicle; and performs filtering of the pitch angle in a running state control mode set based on a vehicle speed and acceleration to change the response of adjustment of the optical axis direction of headlamps so as not to dazzle an oncoming vehicle.

In the above apparatus of Patent Document 1, a pair of height sensors (front and rear ones) for measuring the amounts of change in the front and rear vehicle heights are used to detect the inclination of the vehicle. When this conventional apparatus is applied to a truck or the like having a cab and a cargo bed provided on a frame, the amounts of displacement between the front or rear axle and the frame are detected, and the inclined status of the cab is determined by the difference between the front and rear displacements. Based on this determination, the optical axis of the headlamp is adjusted.

In the truck having the cargo bed provided on the frame, however, the frame is deflected under a load of a cargo, thus making it difficult to determine the inclined status accurately. That is, depending on the position of the cargo, the vertical strokes between the front and rear axles and the frame may be nearly the same, although the frame is deflected and a front end portion of the frame (a portion on the cab side) is inclined upwards. In this case, the optical axis of the headlamp needs to be adjusted so as to be pointed downward. However, it may be determined that there is no inclined state, and this may make it impossible to adjust the optical axis of the headlamp.

### SUMMARY OF THE INVENTION

The present invention has been accomplished in the light of the above-mentioned circumstances. It is the object of the invention to provide an optical axis control device for a vehicle headlamp, which can detect the inclined state of a vehicle with reliability and adjust the optical axis of the headlamp with high accuracy.

To attain the above object, the present invention provides an optical axis control device for a vehicle headlamp, comprising:
optical axis adjusting means for adjusting an optical axis of a headlamp provided in a vehicle;
inclined state detection means for detecting an inclined state of the vehicle relative to a road surface;
first filter means for filtering a detection value of the inclined state detection means;
second filter means for filtering the detection value of the inclined state detection means to a higher degree than the first filter means;
first inclination value establishing means for establishing a first inclination value based on a first detection value obtained by filtering by the first filter means;
second inclination value establishing means for establishing a second inclination value based on a second detection value obtained by filtering by the second filter means; and
control means for taking at least one inclination value among the first inclination value and the second inclination value as an established inclination angle, and controlling the optical axis adjusting means based on the established inclination angle.

According to the above-described features, the control means sets the established inclination angle based on the inclination values obtained by processings by the plural filter means of different degrees of filtering. Consequently, regions, which each filter means alone cannot deal with, can be covered. Based on this established inclination angle, the optical axis adjusting means is adjusted. Thus, the inclined state of the vehicle can be detected stably with high precision, regardless of the road condition. As a result, the optical axis of the headlamp can be adjusted appropriately.

In the optical axis control device, at least one of the first inclination value establishing means and the second inclination value establishing means may include average inclination value computing means for finding an average value of a previous inclination value and a current inclination value. According to this feature, with the filter means requiring a more strict filtering, the difference between the detected value and the inclination value after filtering may increase, broadening the range of the established value. By averaging the inclination values, this range can be minimized, and the accuracy of the inclination value can be improved.

The optical axis control device may further comprise cargo change determination means for determining that a cargo has been changed if a difference between the previous inclination value and the current inclination value established by the first inclination value establishing means or the second inclination value establishing means is a predetermined value or more, and the control means may control the optical axis adjusting means based on an inclination value after cargo change when the cargo change determination means determines that the cargo has been changed. According to this feature, if the cargo has changed, the optical axis adjusting means is controlled based on the inclination value after cargo change. Thus, the inclination value after the cargo change can be established with high accuracy, and the angle of the optical axis can be adjusted to that optimal for the inclined state of the vehicle.

In the optical axis control device, the inclined state detection means may be composed of ultrasonic sensors, and the ultrasonic sensors may be housed in a box-shaped case attached to a cross member of the vehicle via a U-shaped bracket.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic configuration drawing of a truck equipped with an optical axis control device for a vehicle headlamp according to an embodiment of the present invention;

FIG. 2 is a plan view of a frame of the truck;

FIG. 3 is a schematic view of a front portion of the frame of the truck showing the state of mounting of ultrasonic sensors;

FIG. 4 is a sectional view taken on line IV-IV of FIG. 3;

FIG. 5 is a sectional view taken on line V-V of FIG. 4;

FIG. 6 is a schematic view showing the state of mounting of the ultrasonic sensors;

FIGS. 7(a) and 7(b) are explanation drawings of a method for determining the inclined state of a vehicle;

FIG. 8 is a graph showing transmitted waveforms and received waveforms in the ultrasonic sensors;

FIG. 9 is a horizontal sectional view of a headlamp portion mounted with the optical axis control device for the vehicle headlamp;

FIG. 10 is a sectional view taken on line X-X of FIG. 9;

FIG. 11 is a control block diagram of the optical axis control device for the vehicle headlamp in the present embodiment;

FIG. 12 is a flow chart for overall control by the optical axis control device for the vehicle headlamp in the present embodiment;

FIG. 13 is a flow chart for initialization;

FIG. 14 is a flow chart for a stopping procedure;

FIG. 15 is a flow chart for a running procedure (1);

FIG. 16 is a flow chart for a running procedure (2);

FIGS. 17(a) and 17(b) are graphs showing changes in inclination angle data during running and stopping of a vehicle; and

FIG. 18 is a graph showing changes in sensor values and average values of the inclination angle data.

### DETAILED DESCRIPTION OF THE INVENTION

The best mode of an optical axis control device for a vehicle headlamp according to the present invention has first and second filter means for filtering detection values of inclined state detection means to different degrees, and also has first and second inclination value establishing means for establishing first and second inclination values based on first and second detection values obtained by filtering performed by each filter means. In the best mode, control means takes at least one of the first inclination value and the second inclination value as an established inclination angle, and controls optical axis adjusting means based on the established inclination angle. The embodiment of the present invention will be described in detail with reference to the accompanying drawings.

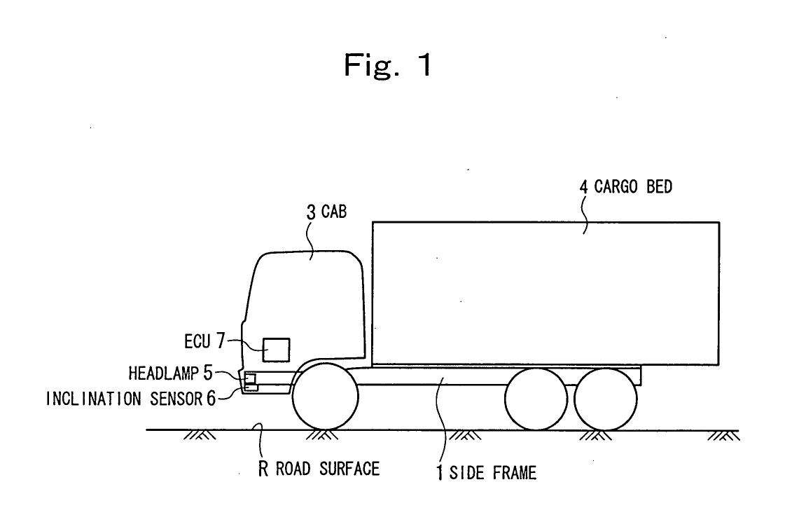

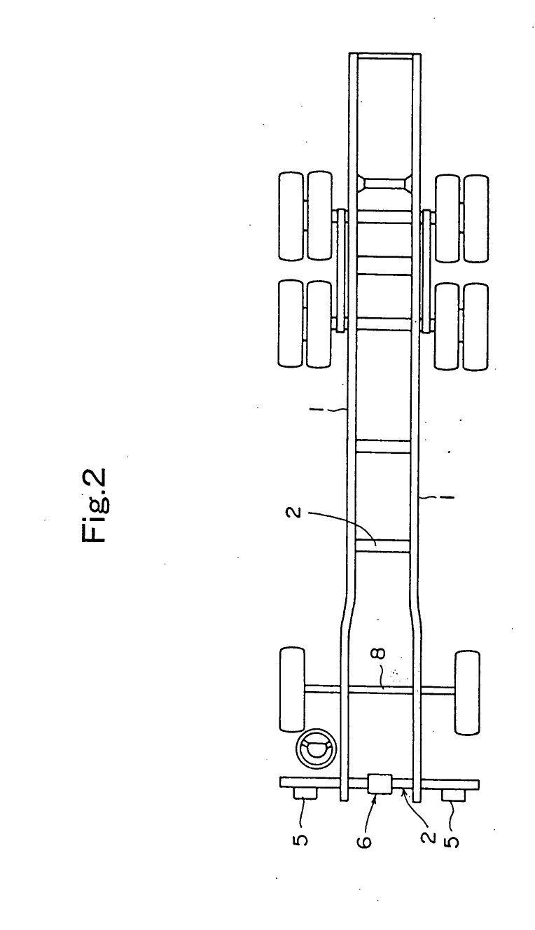

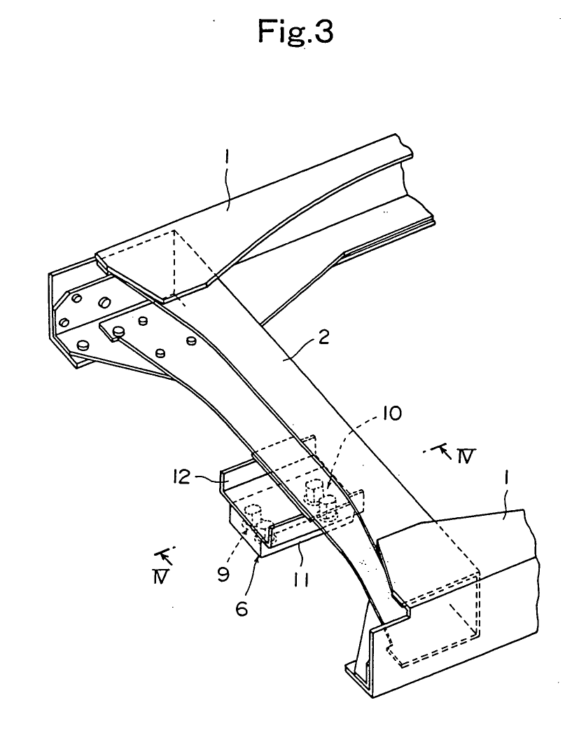

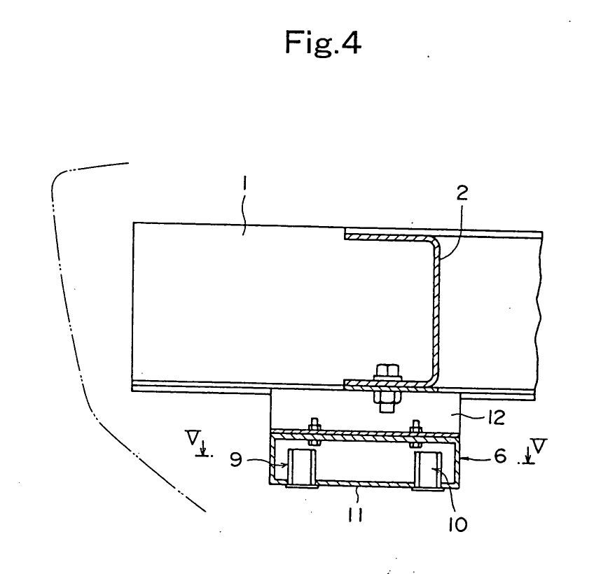

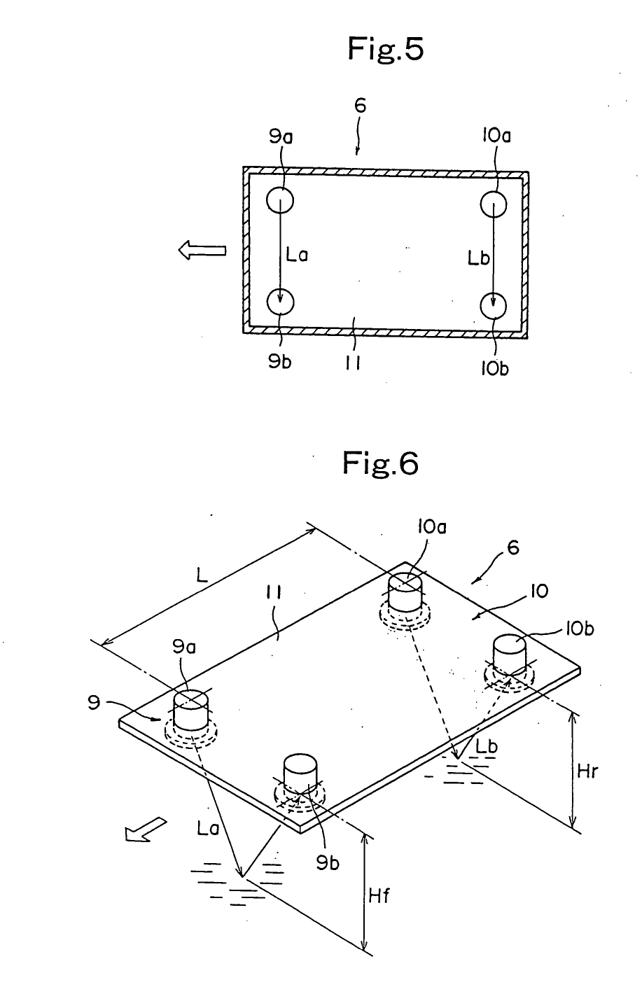

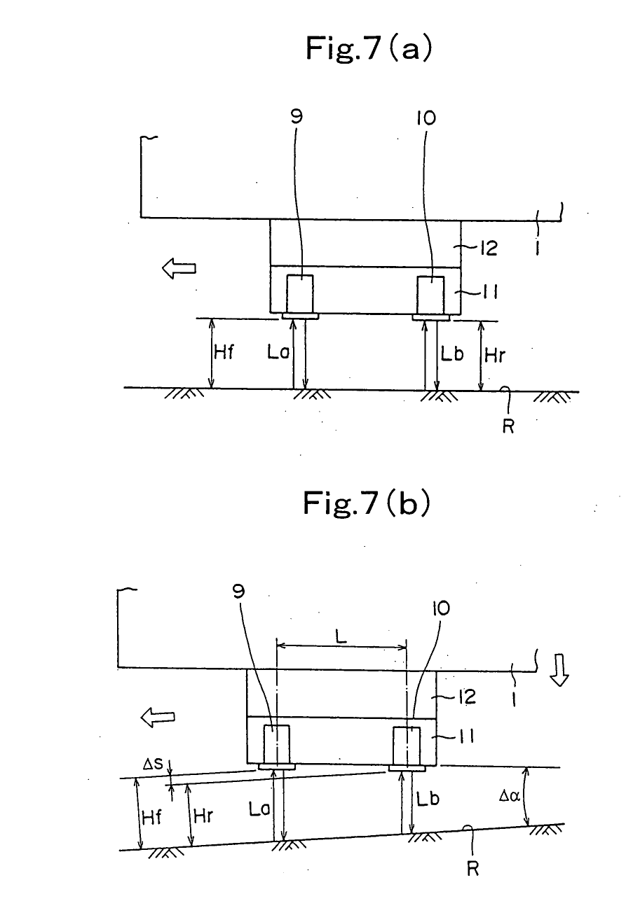

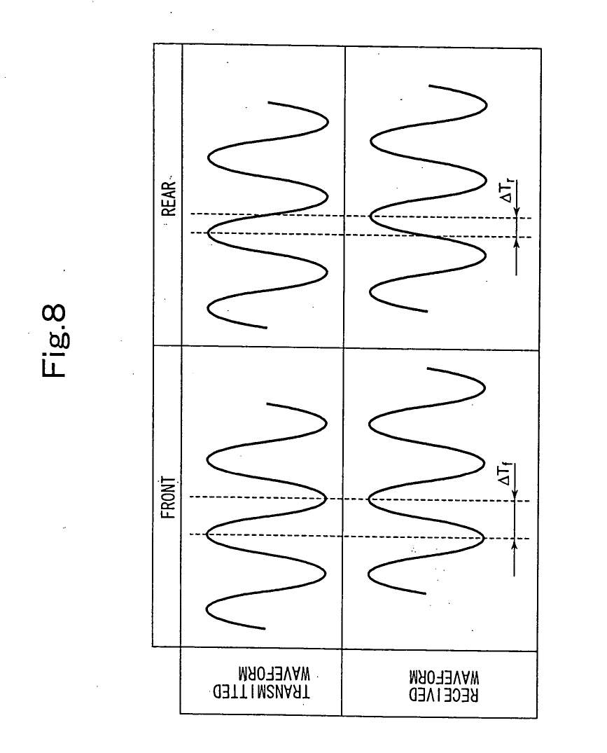

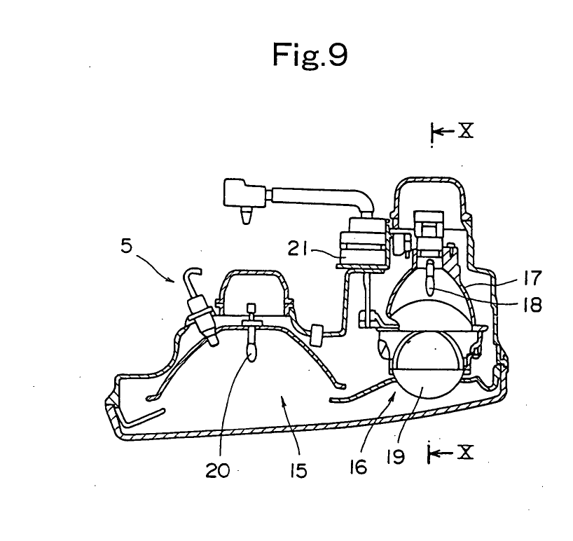

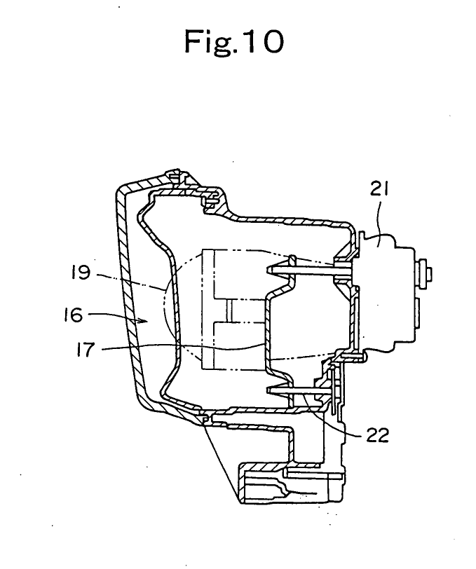

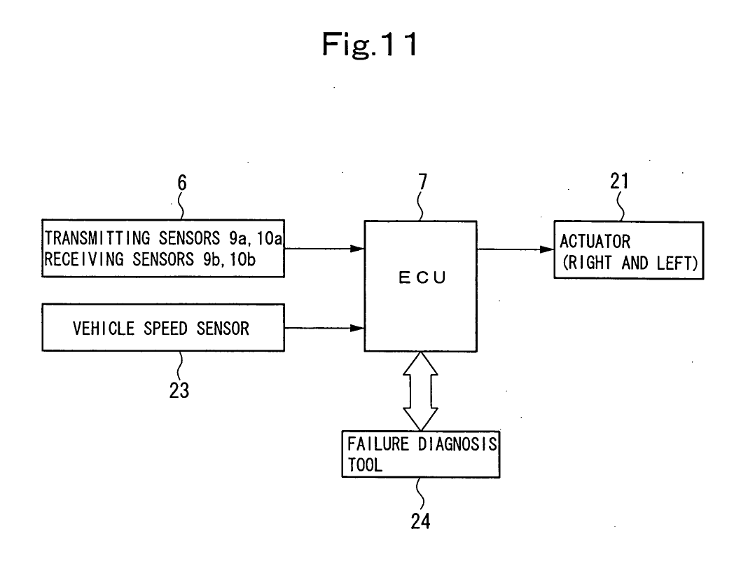

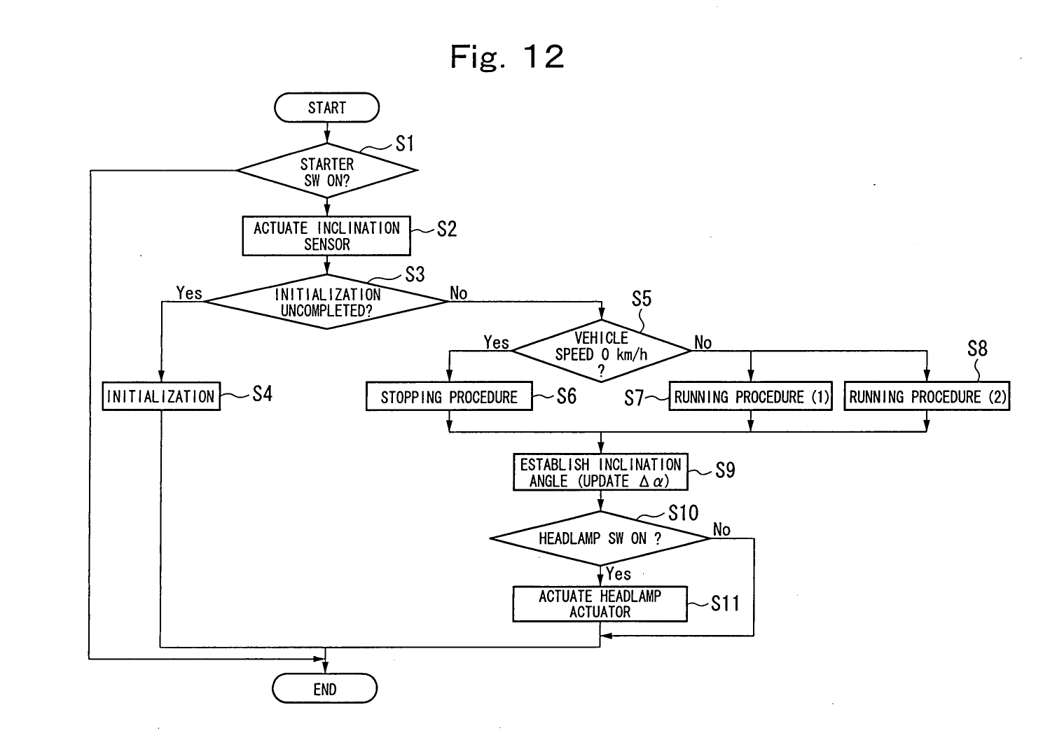

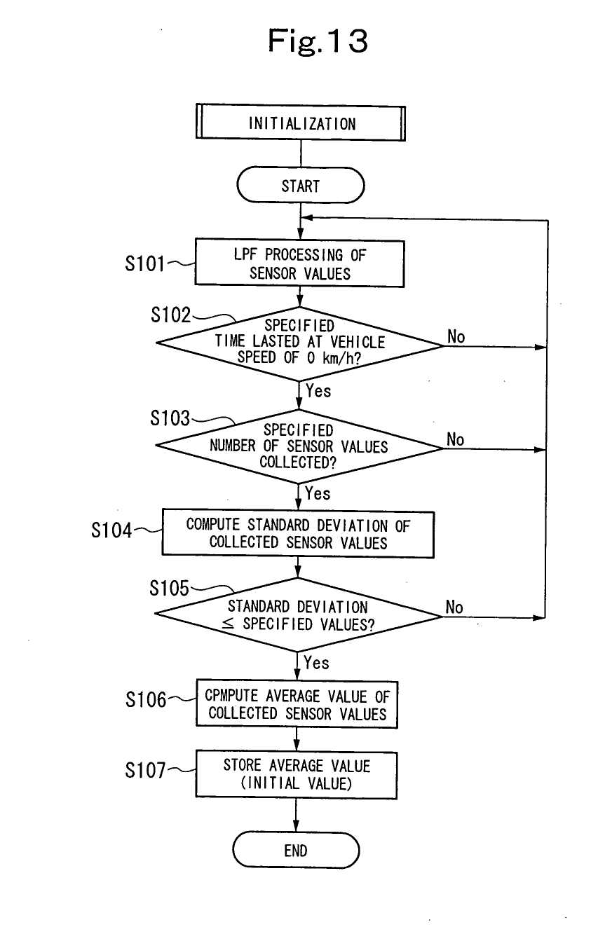

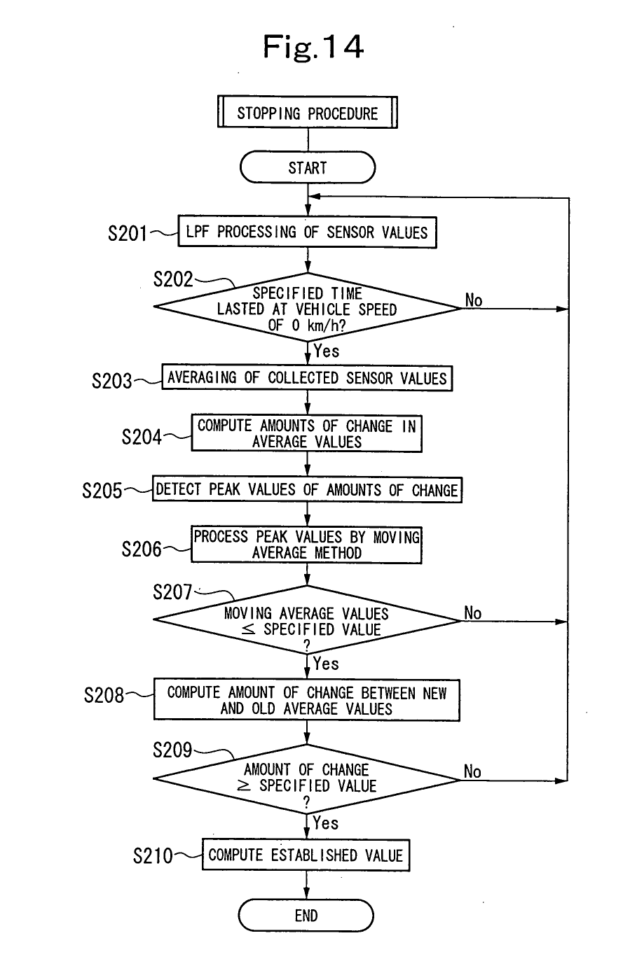

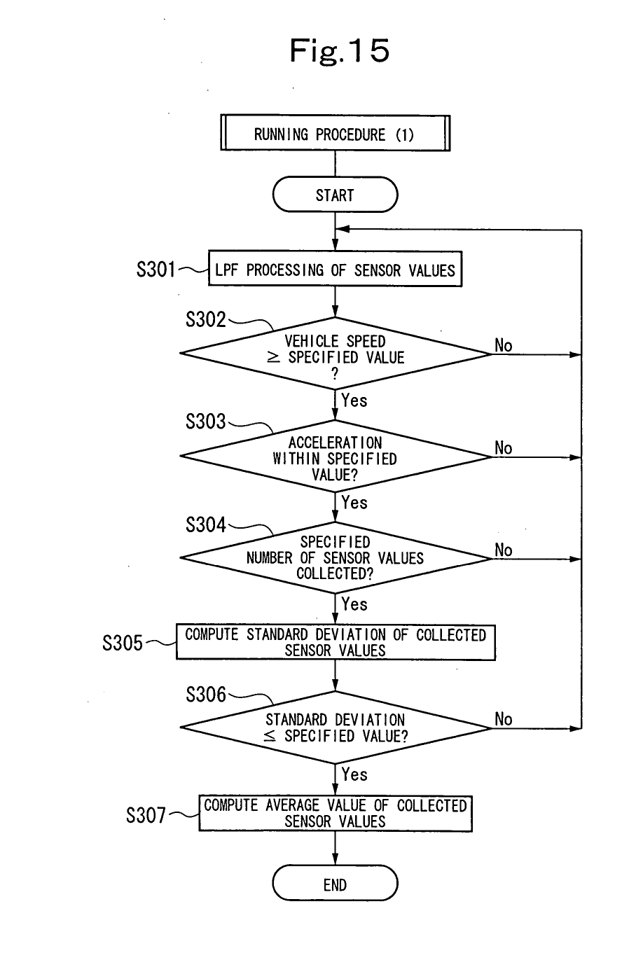

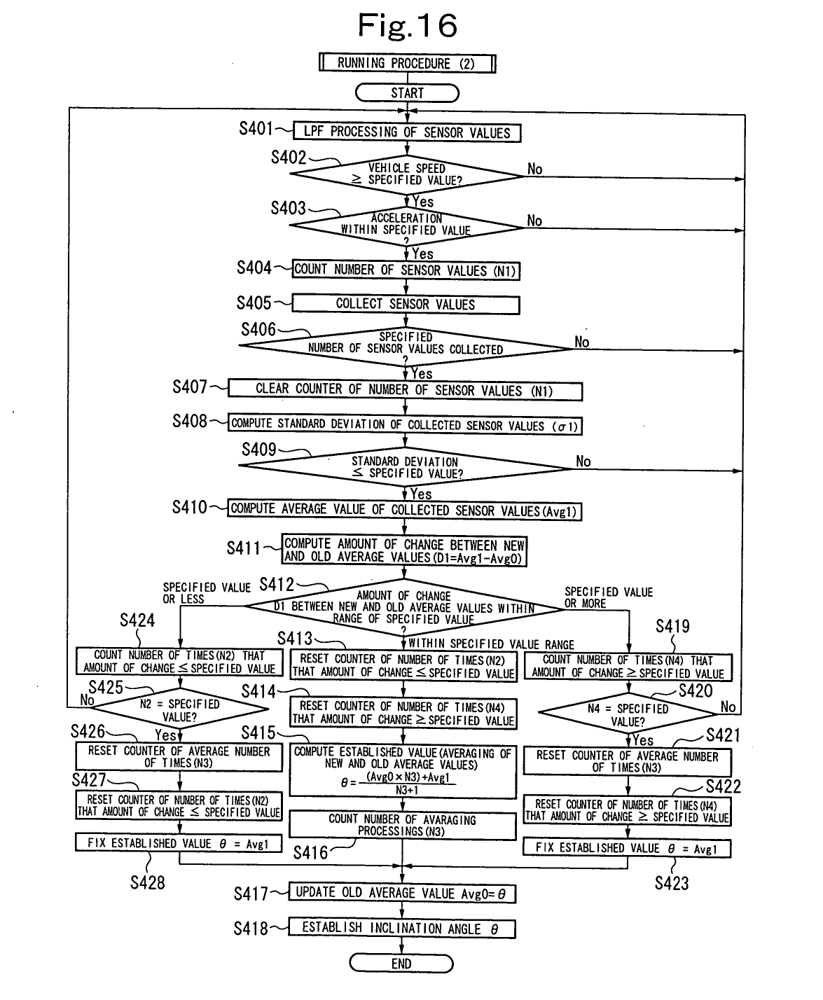

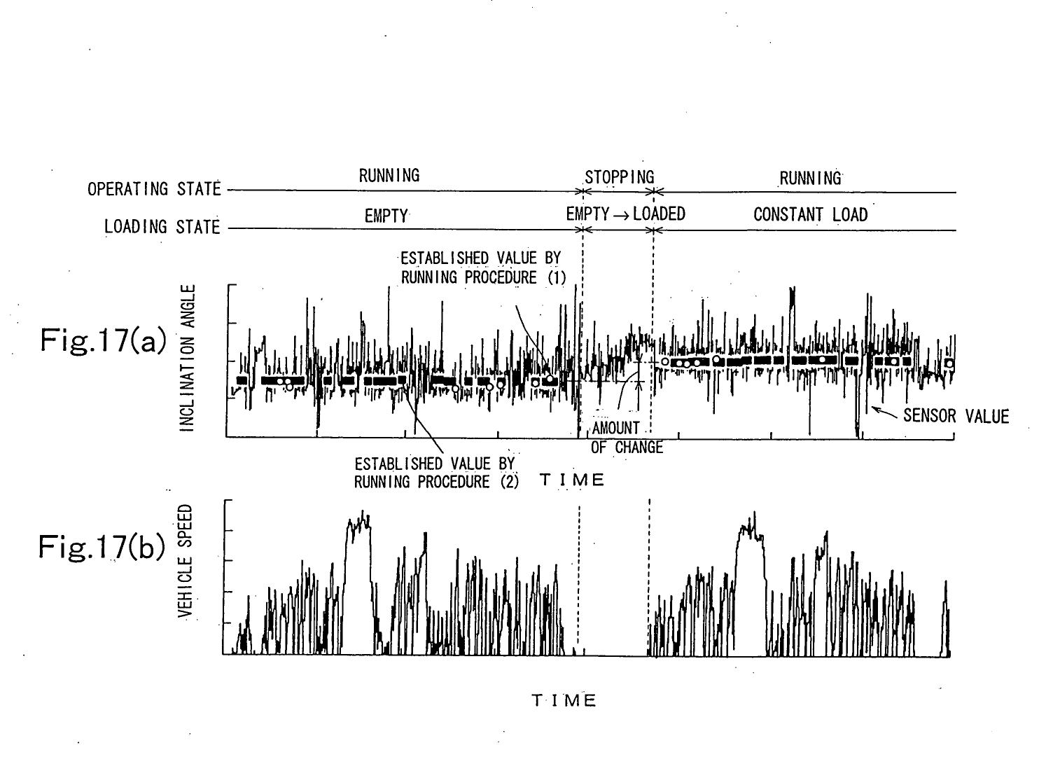

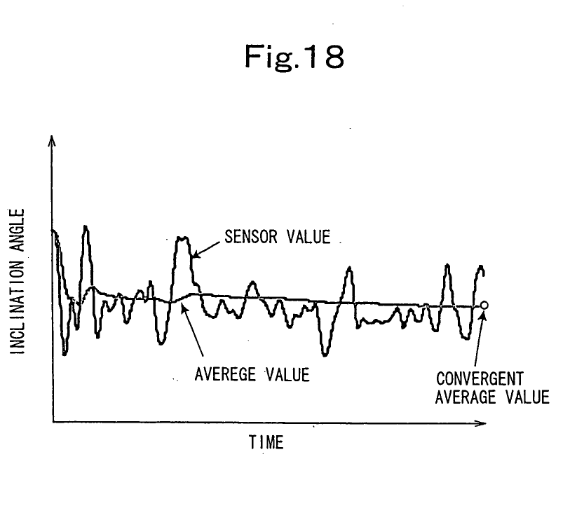

FIG. 1 schematically shows the configuration of a truck equipped with an optical axis control device for a vehicle headlamp according to an embodiment of the present invention. FIG. 2 shows a plan of a frame of the truck. FIG. 3 schematically shows a front portion of the frame, illustrating the state of mounting of ultrasonic sensors. FIG. 4 shows a section taken on line IV-IV of FIG. 3. FIG. 5 shows a section taken on line V-V of FIG. 4. FIG. 6 schematically shows the state of mounting of the ultrasonic sensors. FIGS. 7(a) and 7(b) illustrate a method for detecting the inclined state of a vehicle. FIG. 8 graphically represents transmitted waveforms and received waveforms in the ultrasonic sensors. FIG. 9 shows a horizontal section of a headlamp portion mounted with the optical axis control device for the vehicle headlamp. FIG. 10 shows a section taken on line X-X of FIG. 9. FIG. 11 shows a control block of the optical axis control device for the vehicle headlamp according to the present embodiment. FIG. 12 shows a flow chart for overall control by the optical axis control device for the vehicle headlamp according to the present embodiment. FIG. 13 shows a flow chart for initialization. FIG. 14 shows a flow chart for a stopping procedure. FIG. 15 shows a flow chart for a running procedure (1). FIG. 16 shows a flow chart for a running procedure (2). FIGS. 17(a) and 17(b) graphically represent changes in inclination angle data when the vehicle is running and stopping. FIG. 18 graphically represents changes in sensor values and average values of the inclination angle data.

In an optical axis control device for a vehicle headlamp according to the present embodiment, a plurality of cross members 2 are assembled to, while being perpendicular to, a pair of (i.e., right and left) side frames 1, and a cab 3 and a cargo bed 4 are installed on a frame composed of the side frames 1 and the cross members 2, as shown in FIGS. 1 and 2. Right and left headlamps 5 are mounted on both sides of the cross member 2 in a front end portion of a vehicle, and an inclination sensor 6, as an inclination determination means, is disposed in a nearly central portion of this cross member 2. Detection signals from the inclination sensor 6 are entered into an ECU 7 as control means, and the ECU 7 determines an inclined state of a front portion of the vehicle relative to a road surface based on detection information from the inclination sensor 6.

The right and left headlamps 5 may be provided on the cab 3. The inclination sensor 6 may be provided on an upper side rail of a front axle 8, or if provided forwardly of the front axle 8, may be provided in an end portion of the vehicle other than the cross member 2 (for example, on the cab 3).

The inclination sensor 6 will be describe in detail. As shown in FIGS. 3 to 6, the inclination sensor 6 comprises two ultrasonic sensors 9 and 10 for transmitting and receiving signals in a vehicle width direction, and has two transmitters 9a and 10a as a signal transmitting portion, and two receivers 9b and 10b as a signal receiving portion. The transmitters 9a, 10a are disposed on the right side of the vehicle, while the receivers 9b, 10b are disposed on the left side of the vehicle. The directions of transmitted and received waves of the respective ultrasonic sensors 9 and 10 are nearly parallel to each other, and are nearly perpendicular to the longitudinal direction of the vehicle. The positions of mounting of the transmitters 9a, 10a and the receivers 9b, 10b may be laterally reversed.

The ultrasonic sensors 9, 10 are housed in a box-shaped case 11 such that transmitting and receiving surfaces in their lower portions are exposed. The case 11 is mounted to an intermediate portion of the cross member 2 via a U-shaped bracket 12, so that the inclination sensor 6 is mounted on a front portion of the vehicle in opposed relationship with a road surface R. Because of this arrangement, the mounting space for the inclination sensor 6 can be decreased in the longitudinal direction of the vehicle. By housing the ultrasonic sensors 9, 10 in the case 11, moreover, the inclination sensor 6 can be rendered compact, and can be easily mounted on the cross member 2.

Two of the ultrasonic sensors, 9 and 10, are provided anteriorly and posteriorly such that the transmitters 9a, 10a and the receivers 9b, 10b are separate members. However, this feature is not restrictive, and three of the ultrasonic sensors may be provided. Also, the transmitter and the receiver may be integrally assembled, and two of the transmitter-receiver assemblies may be provided forward and rearward. Alternatively, two receivers may be provided for one transmitter so as to be zigzag in the vehicle width direction or in the longitudinal direction of the vehicle. If there is an ample space for mounting, the transmitters and the receivers can be disposed in a row along the longitudinal direction of the vehicle. Furthermore, laser sensors may be applied as the inclination sensor 6 instead of the ultrasonic sensors.

The inclination sensor 6 determines the inclined state of the vehicle relative to the road surface R based on the difference in the receiving time between the two ultrasonic sensors 9 and 10. Ultrasonic waves from the transmitters 9a, 10a are reflected by the road surface R and received by the receivers 9b, 10b. Based on the difference between the receiving times of the receivers 9b and 10b, the inclined state of the vehicle relative to the road surface R is determined. That is, signals from the transmitters 9a, 10a and the receivers 9b, 10b are entered into the ECU 7, and the inclined state of the front cross member 2 (the inclined state of the front of the vehicle) relative to the road surface is determined by the ECU 7 based on the difference between the times when the receivers 9b, 10b receive ultrasonic waves. The inclination sensor 6 is designed to determine the inclined state of the vehicle relative to the road surface R based on the difference in the receiving time. However, the inclination sensor 6 may be adapted to determine the inclined state of the vehicle relative to the road surface R based on the difference in receiving phase.

The method of determining the inclined state of the vehicle by the inclination sensor 6 will be described in detail with reference to FIGS. 6 to 8.

As shown in FIG. 8, the front and rear transmitters 9a and 10a in the ultrasonic sensors 9, 10 transmit wave-shaped ultrasonic waveforms, while the front and rear receivers 9b and 10b receive the wave-shaped ultrasonic waveforms, which have been transmitted by the transmitters 9a and 10a, with predetermined delays. Thus, transmitting-receiving time differences ΔTf and ΔTr occur, and a receiving time difference ΔT is calculated based on the transmitting-receiving time differences ΔTf and ΔTr. From the results of calculation, an inclination angle Δα of the vehicle is obtained.

That is, as shown in FIG. 6 and FIG. 7(a), when the front portion of the vehicle (the front cross member 2) does not incline relative to the road surface R, the front and rear detected heights Hf and Hr are equal. Thus, a path La of an ultrasonic wave, which is transmitted from the front transmitter 9a to the front receiver 9b, is equal to a path Lb of an ultrasonic wave, which is transmitted from the rear transmitter 10a to the rear receiver 10b (i.e., ΔTf=ΔTr). As a result, the receiving time difference ΔT=(ΔTf−ΔTr)/2 between the front and rear receivers 9b and 10b is zero.

As shown in FIG. 6 and FIG. 7(b), on the other hand, assume that a cargo is loaded on the cargo bed 4, whereby the rear portion of the vehicle sinks, making the front portion of the vehicle inclined rearward (upward) relative to the road surface R. In this case, the front and rear detected heights Hf and Hr are different. Thus, the path La of an ultrasonic wave, which is transmitted from the front transmitter 9a to the front receiver 9b, is longer than the path Lb of an ultrasonic wave, which is transmitted from the rear transmitter 10a to the rear receiver 10b (i.e., ΔTf>ΔTr) As a result, the receiving time difference ΔT occurs between the front and rear receivers 9b and 10b.

When the front portion of the vehicle is inclined rearward, as noted above, a distance difference ΔS occurs in the height direction between the transmitters 9a and 10a separated by a distance L. This distance difference ΔS can be found from the equation (1), indicated below, based on the receiving time difference ΔT, ambient temperature and sound velocity. In this equation, K denotes a coefficient based on ambient temperature and sound velocity. Inclination angle Δα can be calculated from the equation (2), indicated below, based on the distance difference ΔS and the longitudinal distance L between the receivers 9b and 10b.
ΔS=(Hf−Hr)=ΔT×K (1)
Δα=tan−1(ΔS/L) (2)

Thus, the ECU 7 can determine the inclined state of the vehicle by deriving the distance difference ΔS based on the receiving time difference ΔT between the receivers 9b and 10b, and calculating the inclination angle Δα from the above-mentioned equation (2).

In contrast to what is shown in FIG. 7(b) , assume that a cargo is loaded on the cargo bed 4, whereby the front portion of the vehicle sinks, making the front portion of the vehicle inclined forward (downward) relative to the road surface R. In this case, the path Lb is longer than the path La. As a result, the receiving time difference ΔT occurs between the front and rear receivers 9b and 10b. In the same manner as described above, the inclination angle Δα is calculated from the aforementioned equation (2), whereby the inclined state of the vehicle can be determined.

The headlamp 5 and an optical axis control device for it will be described with reference to FIGS. 9 and 10.

As shown in FIGS. 9 and 10, the headlamp 5 is composed of a high-beam lamp 15 and a low-beam lamp 16, and the low-beam lamp 16 is, for example, a high intensity lamp (e.g., a discharge headlamp). The low-beam lamp 16 comprises a high intensity bulb 18 mounted on a reflector holder 17, and has a condenser lens 19. The high-beam lamp 15 has, for example, a halogen bulb 20. The high intensity bulb 18 is tilted, together with the reflector holder 17, by an actuator 21 as an optical axis adjusting means, to have its optical axis adjusted vertically. The actuator 21 is driven by a command issued by the ECU 7 according to the inclined state determined by the ECU 7 based on the information from the inclination sensor 6. As a result, the optical axis of the high intensity bulb 18 is adjusted.

The low-beam lamp 16 is also provided with a manual screw 22 with which to adjust the reflector holder 17 manually, thereby adjusting the optical axis of the high intensity bulb 18. The manual screw 22 is used in setting the position of the optical axis of the high intensity bulb 18 with respect to the initial value of the inclination sensor 6.

It is also possible to adjust the high-beam lamp 15 vertically by the actuator 21 in the same manner as for the low-beam lamp 16. The headlamp is also available as a structure composed of the reflector and the bulb integrated together. If the reflector holder and the bulb are integral, the optical axis of the bulb can be adjusted by tilting the reflector holder by the actuator.

With the optical axis control device for the vehicle headlamp according to the present embodiment configured as above, the ECU 7 receives information from a vehicle speed sensor 23 as an operating state detection means, and also receives detection information from the inclination sensor 6 (transmitters 9a, 10a and receivers 9b, 10b), as shown in FIG. 11. The ECU 7 determines the halt state or running state of the vehicle based on the vehicle speed detected by the vehicle speed sensor 23, and also computes the aforementioned inclination angle Δα based on the detection results from the transmitters 9a, 10a and the receivers 9b, 10b. A drive command is issued to the actuator (the actuator for the right and left headlamps 5) 21 for tilting the reflector holder 17, whereby the optical axis of the high intensity bulb 18 is adjusted into a predetermined state based on the status and the inclined state of the vehicle.

The ECU 7 is also furnished with the function of using the results of the inclination angle Δα, present when the vehicle is empty and on a flat road, as the initial value, and issues a command to store the initial value through a detachable failure diagnosis tool 24. The result of the inclination angle Δα, obtained when the vehicle is empty and on a flat road, is taken up as the initial value and, in this condition, the optical axis of the high intensity bulb 18 is adjusted to a predetermined state by the manual screw 22. Based on the stored initial value, the actuator 21 is driven according to the inclination angle Δα computed from the information fed by the inclination sensor 6 to adjust the optical axis of the high intensity bulb 18 in accordance with the inclined state.

According to the above feature, even if variations exist in the detection status of the inclination sensor 6, it is possible to determine the inclined state always with constant accuracy and adjust the optical axis of the high intensity bulb 18. Furthermore, the command is issued to store the initial value by the failure diagnosis tool 24. Thus, initialization can be performed easily by utilizing the existing device.

The initial value may be stored not by the failure diagnosis tool 24, but by an initial value switch provided on the vehicle body, or by the insertion and extraction of a harness connector.

After the inclination angle Δα computed from the detection information from the transmitters 9a, 10a and the receivers 9b, 10b on the flat road surface is set as the initial value, the high intensity bulb 18 is tilted, together with the reflector holder 17, by the manual screw 22 to adjust the optical axis of the high intensity bulb 18 to the state of the optical axis on the flat road surface. By so doing, it becomes possible to exercise control according to the detection information from the inclination sensor 6 based on the inclination angle Δα computed for the flat road (auto-leveling).

At the time of vehicle shipment from the factory, auto-leveling is started. On this occasion, the inclined state of the vehicle in a stopping state, and the inclined state of the vehicle in a running state (for example, at 40 km/h or more) are detected. The ECU 7 drives the actuator 21 based on the information from the inclination sensor 6 to adjust the optical axis of the high intensity bulb 18.

According to the present embodiment, when the road surface is rough, or the vehicle runs onto a road block or a protrusion, data on the inclined state may respond to this situation, making accurate detection impossible. Thus, filtering for removing high frequency components (for example, frequency components exceeding 0.1 Hz) of the data on the inclined state is performed (first filter means). When many data on the inclined state are collected, and the respective frequency components are examined for deviation, data as high frequency components (for example, data as frequency components exceeding 0.1 Hz) have been confirmed to have sharply increased deviations. Thus, data as high frequency components are removed. This treatment enables the inclined state to be determined by data with relatively few deviations, namely, by data excluding situations where the road surface has irregularities or the vehicle runs onto a road block or protrusion.

If the vehicle is running on a paved road, the road surface may have small irregularities because the surface is covered with snow, or for the purpose of improving a water absorbing function. In this case, even filtering for removing frequency components in excess of 0.1 Hz in the inclined state data may bring about variations in the inclined state data. Subsequent processing may reject the data, resulting in the failure to obtain a predetermined number of data. In the running state of the vehicle, therefore, filtering for removing high frequency components of the inclined state data (e.g., frequency components exceeding 0.05 Hz) is performed (second filter means) in parallel with filtering for removing high frequency components of the inclined state data (e.g., frequency components exceeding 0.1 Hz) (i.e., the first filter means).

If filtering for removing the high frequency components exceeding 0.05 Hz in the inclined state data is performed, processed data may show variations within a certain narrow region, and it maybe impossible to obtain high precision processed data. Thus, when inclination angle data are to be obtained from a plurality of filtered data, processing for obtaining the average of the preceding inclination data and the current inclination data (average inclination value computing means) is performed, and this average value is taken as an established value.

When the vehicle is in a stop state, on the other hand, it is determined whether a cargo has been loaded or unloaded. When there has been loading or unloading, the amount of change in data due to loading or unloading is computed, and this amount of change is added to or subtracted from the existing data on the inclined state to update the data.

That is, while the vehicle is stopping, proper data on the inclined state cannot be obtained, if there is a road seam, a road block or a protrusion on the road surface detected by the inclination sensor 6. Thus, data on the inclined state are collected, and processed by the moving average method. When the average values obtained by this processing converge within a predetermined range, the convergent average values are stored in memory. The difference between the maximum value and the minimum value of the convergent average values is set as an amount of change in the data on the inclined state (change amount computing means). When this amount of change is not smaller than a set amount of change which has been preset, this amount of change is added to or subtracted from the current inclination angle data to update the data. During a halt of the vehicle, the collected data have been confirmed to vary within a narrow range because of the occupant's ingress or egress or engine vibrations. When the cargo is loaded or unloaded, on the other hand, the collected data have been confirmed to vary within a wide range.

The method of updating vehicle inclination angle data by the optical axis control device for a vehicle headlamp according to the present embodiment will be described in detail with reference to FIGS. 12 to 16.

As shown in FIG. 12, when auto-leveling is started, it is determined in Step S1 whether a starter SW is on or not. Upon determination that the starter SW is on, the inclination sensor 6 is actuated in Step S2 to compute the inclination angle Δα. After computation of the inclination angle Δα in Step S2, it is determined in Step S3 whether the initialization of the system has been uncompleted. If the initialization of the system has been found to be uncompleted in Step S3, initialization is executed in Step S4. If the initialization of the system has been completed in Step S3, on the other hand, it is determined in Step S5 whether the vehicle speed is 0 km/h or not. Upon determination in Step S5 that the vehicle speed is 0 km/h, it is determined that the vehicle is stopping. The program proceeds to Step S6, executing a stopping procedure. If the vehicle speed has been found not to be 0 km/h, it is determined that the vehicle is running. The program shifts to Step S7 and Step S8 to execute a running procedure (1) and a running procedure (2) in parallel.

After execution of various processings in Steps S6, S7 and S8, the inclination angle Δα is fixed as an established value. Then, in Step S9, data on the inclination angle Δα is updated, and then in Step S10, it is determined whether a lamp SW for lighting the headlamp 5 is ON or not. If a determination is made that the lamp SW is ON, the actuator 21 is driven in Step S11 to adjust the optical axis of the high intensity bulb 18 to the inclination angle Δα. If it is determined in Step S10 that the lamp SW is not ON, the state of retention of data on the inclination angle Δα is maintained.

In connection with the above-mentioned initialization, as shown in FIG. 13, filtering for removing high frequency components (frequency components exceeding 0.1 Hz) from the data on the inclination angle Δα by a low pass filter (first filter means) is executed in Step S101. This filtering removes data, which are obtained when the road surface has irregularities or the vehicle runs onto a road block or protrusion, from the data on the inclination angle Δα. As a result, proper data on the inclined state can be obtained. In Step S102, it is determined whether the state of the vehicle speed being 0 km/h has lasted for a specified period of time (for example, 5 seconds) . Upon determination that the state of the vehicle speed being 0 km/h has lasted for the specified time, it is determined that the vehicle is stopping. The program proceeds to Step S103. In Step S103, it is determined whether a specified number of (for example, 500) sensor values (data on the inclination angle Δα) have been collected or not. If a determination is made that the specified number of the data have been collected, a standard deviation is computed based on the collected data in Step S104. In Step S105, the calculated standard deviation is an initial specified value (for example, σ≦0.3 deg) or less. Upon determination that the standard deviation is the initial specified value or less, the program proceeds to Step S106. In Step S106, computation is made of an average value for the data for which it is determined that the standard deviation is the initial specified value or less. The average value is stored as the initial value in Step S107.

In the stopping procedure, as shown in FIG. 14, filtering for removing high frequency components (frequency components exceeding 0.1 Hz) from the data on the inclination angle Δα by a low pass filter (first filter means) is executed in Step S201. By this filtering, data, which are obtained when the road surface has irregularities or the vehicle runs onto a road block or protrusion, are removed from the data on the inclination angle Δα. Thus, proper data on the inclined state can be obtained. In Step S202, it is determined whether the state of the vehicle speed being 0 km/h has lasted for a specified period of time (for example, 10 seconds). Upon determination in Step S202 that the state of the vehicle speed being 0 km/h has lasted for the specified time, it is determined that the vehicle is stopping. The program proceeds to Step S203. In Step S203, the sensor values (data on the inclination angle Δα) are taken in, and subjected to the moving average method. In Step S204, the amounts of change in the average values are computed. In Step S205, the upper and lower peak values of the sensor values are sequentially taken in. In Step S206, the peak values taken in are subjected to the moving average method. In Step S207, it is determined whether the computed average values have converged within a predetermined range. If it is determined that the average values have converged within the predetermined range, the converged average values are stored in memory as convergent average values. In Step S208, the amount of change between the maximum value and the minimum value of the convergent average values is computed. If a determination is made in Step S207 that the average values do not converge within the predetermined range, the program shifts to Step S201 to repeat its processing. If the convergent average value found in Step S207 is only one, the amount of change computed in Step S208 is zero.

After computation of the amount of change in Step S208, it is determined in Step S209 whether the amount of change is equal to or greater than a specified value which has been preset. If the amount of change is judged to be equal to or greater than the specified value, a determination is made that a cargo has been loaded or unloaded. Thus, the program proceeds to Step S210. Here, the amount of change calculated is established as an amount of change for data updating.

As described above, it is determined whether the cargo has been loaded or unloaded, with the vehicle in a stopping state. When the cargo has been loaded or unloaded, data on the inclination angle Δα is promptly updated. Regardless of the irregularities of the road surface, data on the inclination angle Δα can be updated reliably and promptly.

In the run procedure (1), as shown in FIG. 15, filtering for removing high frequency components (frequency components exceeding 0.1 Hz) from the data on the inclination angle Δα by a low pass filter (first filter means) is executed in Step S301. By this filtering, data, which are obtained when the road surface has irregularities or the vehicle runs onto a road block or protrusion, are removed from the data on the inclination angle Δα. Thus, proper data on the inclined state can be obtained. In Step S302, it is determined whether the vehicle speed is a specified value or higher. The specified value is set at a value less than a vehicle speed at which there are many variations in data on the inclined state, for example, set at 20 km/h. When a determination is made in Step S302 that the vehicle speed is the specified value or higher, Step S303 determines whether the acceleration or deceleration of the vehicle is within a specified value. The specified value at this time is set at a value which is not deemed to represent an accelerated or decelerated state; for example, it is set at ±0.5 m/S².

Upon determinations in Step S302 that the vehicle speed is the specified value or higher, and in Step S303 that the acceleration or deceleration is within the specified value, it is determined in Step S304 whether a specified number of (for example, 300) data on the inclination angle Δα have been collected or not. If a determination is made that the specified number of the data have been collected, a standard deviation is computed based on the collected data in Step S305. If it is determined in Step S304 that the specified number of data have not been collected, the program returns to Step S301, performing processings repeatedly until the specified number of data are collected.

After computation of the standard deviation in Step S305, it is determined in Step S306 whether the standard deviation is a running specified value (for example, σ=0.14 deg) or less. Upon determination that the standard deviation is the running specified value or less, the program proceeds to Step S307. In Step S307, computation is made of an average value for the data for which it is determined that the standard deviation is the running specified value or less. The calculated average value is taken as an established value for data updating. The processings in Steps S305 to S307 constitute the first inclination value establishing means of the present invention.

As described above, when the vehicle is judged to be in a running state, and only when the vehicle is in such a running state, data updating is performed using data on the inclination angle Δα from which the frequency components exceeding 0.1 Hz have been removed by filtering. Thus, data on the vehicle at a low speed or during sudden acceleration or deceleration can be excluded, and data on the inclination angle Δα in a running situation with few variations can be adopted.

In the running procedure (2), as shown in FIG. 16, filtering for removing high frequency components (frequency components exceeding 0.05 Hz) from the data on the inclination angle Δα by a low pass filter (second filter means) is executed in Step S401. By this filtering, data, which are obtained when the road surface has tiny irregularities or the vehicle runs onto a road block or protrusion, are removed from the data on the inclination angle Δα. Thus, proper data on the inclined state can be obtained. In Step S402, it is determined whether the vehicle speed is a specified value or higher. The specified value is set at a value less than a vehicle speed at which there are many variations in data on the inclined state, for example, set at 5 km/h. When a determination is made in Step S402 that the vehicle speed is the specified value or higher, Step S403 determines whether the acceleration or deceleration of the vehicle is within a specified value. The specified value at this time is set at a value which is not deemed to represent an accelerated or decelerated state; for example, it is set at ±0.5 m/S².

Upon determinations in Step S402 that the vehicle speed is the specified value or higher, and in Step S403 that the acceleration or deceleration is within the specified value, counting (N1) of the number of the sensor values (inclination angle Δα) is started in Step S404, and the collection of the sensor values is started in Step S405. In Step S406, it is determined whether a specified number of (for example, N1=300) data on the inclination angle Δα have been collected or not. If a determination is made that the specified number of the data have been collected, the count of the sensor values (N1) is cleared in Step S407, whereafter a standard deviation σ1 is computed based on the collected data in Step S408. If it is determined in Step S406 that the specified number of data have not been collected, the program returns to Step S401, performing processings repeatedly until the specified number of data are collected.

After computation of the standard deviation in Step S408, it is determined in Step S409 whether the standard deviation is a running specified value (for example, σ=0.14 deg) or less. Upon determination that the standard deviation is the running specified value or less, the program proceeds to Step S410. In Step S410, computation is made of an average value Avg1 for the data for which it is determined that the standard deviation is the running specified value or less. In Step S411, the amount of change, D1, between the preceding average value Avg0 and the current average value Avg1 is computed. In Step S412, it is determined whether this amount of change D1 between the new and old average values is within the range of a preset specified value (for example, −0.3 deg<D1<0.3 deg).

If the amount of change D1 between the new and old average values is not within the range of the specified value in Step S412, it is determined that there has been a change in the cargo, although the vehicle is running. That is, if the amount of change D1 is the specified value range or less (for example, D1≦−0.3 deg), it is assumed that the weight of the cargo has decreased. In this case, the program shifts to Step S424, starting counting (N2) of the number of times that the data, for which the amount of change D1 has been the specified value range or less, has been continuously detected. If the amount of change D1 is the specified value range or more (for example, D1≧0.3 deg), it is assumed that the weight of the cargo has increased. In this case, the program shifts to Step S419, starting counting (N4) of the number of times that the data, for which the amount of change D1 has been the specified value range or more, has been continuously detected. If the amount of change D1 between the new and old average values lies within the range of the specified value in Step S412, it is determined that there has been no change in the cargo. In Step S413, the count (N2) of the data is reset, whereafter in Step S414, the count (N4) of the data is reset. In Step S415, the averaging of the new and old average values of the data on the inclination angle Δα is performed.

In detail, the preceding average value Avg0 is multiplied by the count (N3) of the number of processings to obtain the preceding total value. The current average value Avg1 is added to this preceding total value to obtain a total value including the current value. This total value is divided by the number of processings, including the current processing, to compute an established value θ. When the inclination established value θ, including the current average value Avg1, is calculated in Step S415, the number of processings is counted (N3) in Step S416. In Step S417, the preceding average value Avg0 is changed to the calculated inclination established value θ. In Step S418, an update is performed with the inclination established value θ.

If the amount of change D1 is the specified value range or less (for example, D1≦−0.3 deg) in Step S412, on the other hand, counting (N2) of the number of detections is started in Step S424. In Step S425, it is confirmed that this data has been detected continuously a specified number of times (for example, 3 times) . Then, the count (N3) of the number of processings is reset in Step S426, and the count (N2) of the number of detections is reset in Step S427. In Step S428, the average value Avg1, for which the amount of change D1 has been the specified value range or less, is established as the inclination established value θ for updating. If the amount of change D1 is the specified value range or more (for example, D1≧0.3 deg) in Step S412, on the other hand, counting (N4) of the number of detections is started in Step S419. In Step S420, it is confirmed that this data has been detected continuously a specified number of times (for example, 3 times). Then, in Step S421, the count (N3) of the number of processings is reset, and in Step 422, the count (N4) of the number of detections is reset. In Step S423, the average value Avg1, for which the amount of change D1 has been the specified value range or more, is established as the inclination established value θ for updating. The processings of Steps S415 to S418 constitute the second inclination value establishing means of the present invention. The processings of Steps S411 to S417 constitute the average inclination value computing means of the present invention. Furthermore, the processing of Step S412 constitutes the load change determination means of the present invention.

As described above, when the vehicle is judged to be in a running state, and only when the vehicle is in such a running state, data updating is performed using data on the inclination angle Δα from which the frequency components exceeding 0.05 Hz, a value less than 0.1 Hz, have been removed by filtering. Thus, data on the vehicle at a low speed or during sudden acceleration or deceleration can be excluded. Moreover, the difference between the detected value and the inclination value after filtering may increase, and the range of the established value may widen. However, averaging makes it possible to adopt high precision data on the inclination angle Δα in a running situation.

In a running state of the vehicle, the running procedure (1) and the running procedure (2) are simultaneously performed in parallel. As a result, the established inclination angle is set based on the data on the inclination angle Δα processed by the two filter means of different degrees of filtering. Thus, regions, which each filter means alone cannot deal with, can be covered, so that the inclined state of the vehicle can be detected stably with high precision, regardless of the road condition.

The method of processing the data on the inclination angle Δα in the aforementioned stopping state of the vehicle will be described concretely. As shown in FIG. 17, when the vehicle shifts from an empty running state to a stopping state, the inclination sensor 6 outputs sensor values varying upwardly and downwardly within a predetermined range, regardless of the state of the detected road surface targeted by the inclination sensor 6. The reason is that when the vehicle stops, there are no displacements of the vehicle body due to the state of the road surface. However, the vehicle body is displaced because of ingress and egress of occupants, engine vibrations, etc. On this occasion, the ECU7 takes in the data on the inclination angle Δα, processes the data by the moving average method, and stores those average values, which converge within a predetermined range, as convergent average values. That is, as shown in FIG. 18, the upper and lower peak values of the sensor values outputted by the inclination sensor 6 are sequentially taken in and subjected to moving average processing. If the computed average values converge to a nearly constant level, the average value at this time is taken as a convergent average value, and the convergent average values obtained in this manner are plotted.

This procedure is repeatedly performed to plot a multiplicity of the convergent average values. Based on these convergent average values, the deviation between the maximum value and the minimum value, namely, the amount of change, is computed. If an unloaded condition (or a laden condition) continues when the vehicle is stopping, the range of upward and downward variations in the sensor values is narrow for the aforementioned reasons. If loading (or unloading) is performed, by contrast, the range of variations in the sensor values is wide, and the convergent average values also vary. Thus, if the amount of change between the maximum value and the minimum value among the convergent average values is a preset specified value or more, it is determined that loading (or unloading) has taken place. Using this amount of change as an established value, the current data on the inclination angle Δα is updated. Thus, at a time when unloading is carried out to bring the vehicle into an empty condition, the optical axis of the high intensity bulb 18 can be adjusted promptly and properly based on the latest data on the inclination angle Δα.

The present embodiment collects the data on the inclination angle Δα from which the frequency components exceeding 0.1 Hz have been removed by the first filter means (i.e., the data indicated by an unfilled circle ◯ in FIG. 17), and the data on the inclination angle Δα from which the frequency components exceeding 0.05 Hz have been removed by the second filter means (i.e., the data indicated by a filled square ▪ in FIG. 17). Even if a paved road has a finely rough road condition because of a snow-covered surface, or for an improved water absorbing function, the data can be acquired reliably. Since the data on the inclination angle Δα are obtained continuously all the time, the optical axis of the high intensity bulb 18 can be adjusted properly.

The optical axis control device for a vehicle headlamp according to the present embodiment, as described above, detects the inclined state (inclination angle Δα) of the vehicle relative to the road surface during a running. Furthermore, this control device carries out, in parallel, filtering for removing the high frequency components of the detection data (the frequency components exceeding 0.1 Hz) (processing by the first filter means), and filtering for removing the high frequency components of the detection data (the frequency components exceeding 0.05 Hz) (processing by the second filter means).

Hence, the established inclination angle is set based on the data on the inclination angle Δα processed by the two filter means of different degrees of filtering. Consequently, regions, which each filter means alone cannot deal with, can be covered. Based on this established inclination angle, the inclination angle of the headlamp 5 is adjusted. Thus, the inclined state of the vehicle can be detected with high precision, regardless of the road condition, and the optical axis of the headlamp can be adjusted properly. In detail, if the paved road has a finely rough road condition because of a snow-covered road surface, or for an improved water absorbing function, filtering for removing the frequency components exceeding 0.1 Hz in the data on the inclined state may result in variations in the data on the inclined state. In this case, subsequent processing may reject the data, and may be unable to give a predetermined number of data. In parallel with such filtering, however, filtering for removing the frequency components exceeding 0.05 Hz in the data on the inclined state is performed in the present embodiment. By applying data obtained through both types of filtering, a predetermined number of data can be acquired reliably.

Besides, the average value of the previous inclination value and the current inclination value is obtained for the data acquired by filtering for removing the high frequency components (the frequency components exceeding 0.05 Hz) of the detection data by means of the second filter means. With the filter means requiring a more strict filtering, the difference between the detected value and the inclination value after filtering may increase, broadening the range of the established value. By averaging the inclination values, this range can be minimized, and the accuracy of the inclination value can be improved. Furthermore, if the difference between the previous inclination value and the current inclination value is a predetermined value or more, it is determined that the cargo has changed. Based on the inclination value after the change in the cargo, the optical axis of the headlamp is adjusted. In this manner, the inclination value after the change in the cargo can be established with high accuracy, and the angle of the optical axis can be adjusted to that optimal for the inclined state of the vehicle.

In a stopping state of the vehicle, the inclined state (inclination angle Δα) of the vehicle relative to the road surface is detected; the amount of change of the inclined state is computed based on the inclined state (inclination angle Δα) of the vehicle; if this amount of change is a specified value or more, the amount of change is added to or subtracted from the current inclination angle Δα to update the data; and the actuator 21 is driven based on the updated new inclination angle Δα to correct the inclination angle of the headlamp 5. That is, loading or unloading of the cargo is determined by the magnitude of the amount of change, and the inclination angle Δα is updated based on the inclined state and the amount of change to adjust the inclination angle of the headlamp 5. Thus, regardless of the state of the road surface, the inclined state of the vehicle, which has stopped, can be detected with high accuracy, and the optical axis of the headlamp can be adjusted appropriately.

While the present invention has been described by the above embodiment, it is to be understood that the invention is not limited thereby, but may be varied or modified in many other ways. For example, in the above-described embodiment, averaging of the data (Steps S411 to 428) is performed in the running procedure (2), but may be applied during the process of the running procedure (1). Moreover, the region for filtering by the first filter means is set to be the frequency components exceeding 0.1 Hz, and the region for filtering by the second filter means is set to be the frequency components exceeding 0.05 Hz. However, these frequencies are not limitative, but appropriate frequencies may be set according to the status of detection, the detection accuracy of equipment, and so forth. Furthermore, the various numerical values illustrated in the above-mentioned embodiment are not restricted, but appropriate values may be set. Such variations or modifications are not to be regarded as a departure from the spirit and scope of the invention, and all such variations and modifications as would be obvious to one skilled in the art are intended to be included within the scope of the appended claims.

1. An optical axis control device for a vehicle headlamp, comprising:
optical axis adjusting means for adjusting an optical axis of a headlamp provided in a vehicle;
inclined state detection means for detecting an inclined state of said vehicle relative to a road surface;
first filter means for filtering a detection value of said inclined state detection means;
second filter means for filtering said detection value of said inclined state detection means to a higher degree than said first filter means;
first inclination value establishing means for establishing a first inclination value based on a first detection value obtained by filtering by said first filter means;
second inclination value establishing means for establishing a second inclination value based on a second detection value obtained by filtering by said second filter means; and
control means for taking at least one inclination value among said first inclination value and said second inclination value as an established inclination angle, and controlling said optical axis adjusting means based on said established inclination angle.

2. The optical axis control device for a vehicle headlamp according to claim 1, wherein
at least one of said first inclination value establishing means and said second inclination value establishing means includes average inclination value computing means for finding an average value of a previous inclination value and a current inclination value.

3. The optical axis control device for a vehicle headlamp according to claim 2,
further comprising cargo change determination means for determining that a cargo has been changed if a difference between said previous inclination value and said current inclination value established by said first inclination value establishing means or said second inclination value establishing means is a predetermined value or more, and
wherein said control means controls said optical axis adjusting means based on an inclination value after cargo change when said cargo change determination means determines that said cargo has been changed.

4. The optical axis control device for a vehicle headlamp according to claim 1, wherein
said inclined state detection means is composed of ultrasonic sensors, and
said ultrasonic sensors are housed in a box-shaped case attached to a cross member of said vehicle via a U-shaped bracket.
